(19) United States
(12) Patent Application Publication
(10) Pub. No.: US 2026/0225579 A1
(43) Pub. Date: Aug. 6, 2026

(54) METHOD FOR IMPROVING RIDE COMFORT DURING SMART CRUISE CONTROL OPERATION AND APPARATUS AND SYSTEM THEREFORE

(71) Applicants: HYUNDAI MOTOR COMPANY, SEOUL (KR); KIA CORPORATION, SEOUL (KR); KOREA UNIVERSITY OF TECHNOLOGY AND EDUCATION INDUSTRY-UNIVERSITY COOPERATION FOUNDATION, CHOENAN-SI (KR)

(72) Inventors: Jee Yoon Suh, Hwaseong-si (KR); Seung Han You, Seoul (KR); Wan Ki Cho, Suwon-si (KR)

(73) Assignees: HYUNDAI MOTOR COMPANY, SEOUL (KR); KIA CORPORATION, SEOUL (KR); KOREA UNIVERSITY OF TECHNOLOGY AND EDUCATION INDUSTRY-UNIVERSITY COOPERATION FOUNDATION, CHOENAN-SI (KR)

(21) Appl. No.: 19/236,301

(22) Filed: Jun. 12, 2025

(30) Foreign Application Priority Data
Feb. 5, 2025 (KR) 10-2025-0014796

(51) Int. Cl. B60W 30/02; B60W 30/16; B60W 50/00

(52) U.S. Cl. CPC B60W 30/025; B60W 30/162; B60W 50/00; B60W 2050/0005; B60W 2050/0014; B60W 2720/40

(57) ABSTRACT

A method for improving ride comfort during an operation of smart cruise control includes receiving, by a processor, information on a target longitudinal acceleration from a smart cruise control (SCC) controller equipped in the vehicle, determining, by the processor, a power for tracking the target longitudinal acceleration, and distributing, by the processor, the determined power to front and rear wheels.

### CROSS REFERENCE TO RELATED APPLICATIONS

This application claims priority to and the benefit of Korean Patent Application No. 10-2025-0014796, filed with the Korean Intellectual Property Office on Feb. 5, 2025, the entire contents of which are incorporated herein by reference.

### BACKGROUND

### (a) Field

The present disclosure relates to a technique for improving vehicle ride comfort, and more particularly, to a technique for distributing front and rear torques for improving ride comfort in a case of operating smart cruise control.

### (b) Description of the Related Art

Smart cruise control (SCC) is an advanced driver assistance system (ADAS) that controls a vehicle to travel at a speed set by a driver via a speed setting lever without the need for pedal manipulation.

SCC provides driver convenience by allowing the driver to take his or her foot off an accelerator pedal during long-distance driving, an also has an advantage of improving fuel efficiency.

Recently, advanced cruise control has been further enhancing driver convenience by incorporating features that utilize sensors such as front cameras and radars to maintain a consistent speed, automatically adjust acceleration and deceleration based on a distance to a vehicle ahead, and recognize entry and exit situations on highways to automatically reduce the speed.

Recently, research on a vehicle motion control method to improve vehicle ride comfort in a case of operating SCC is also actively being conducted.

To improve the ride comfort during an operation of the SCC, the issue of compatibility between required target acceleration estimation performance and the ride comfort should be addressed.

In a vehicle equipped with an advanced cruise control function, ride comfort issues caused by pitch resulting from the performance of maintaining a distance from a preceding vehicle and acceleration/deceleration due to presence, absence, or change of the preceding vehicle should also be considered.

Accordingly, development of vehicle motion control (VMC) technology that satisfies both ride comfort and stability for passengers during autonomous driving is required.

### SUMMARY

The present disclosure attempts to provide a method for improving ride comfort during an operation of smart cruise control and an apparatus therefore.

The present disclosure also attempts to provide a method for improving ride comfort during an operation of smart cruise control and an apparatus therefore, capable of efficiently distributing driving and braking powers to front and rear wheels to minimize vertical movement of a vehicle in a case where it is necessary to control the vehicle longitudinally with a new longitudinal acceleration.

The present disclosure also attempts to provide a method for improving ride comfort during an operation of smart cruise control and an apparatus therefore, capable of determining and applying an optimal front-rear braking power distribution ratio that minimizes an objective function between ride comfort and stability in a case where it is necessary to control the vehicle longitudinally with a new longitudinal acceleration.

The technical objects of the present disclosure are not limited to the objects mentioned above, and other technical objects not mentioned may be clearly understood by those skilled in the art from the description of the claims.

An embodiment of the present disclosure provides a vehicle ride comfort improving method including receiving, by a processor, information on a target longitudinal acceleration from a smart cruise control (SCC) controller equipped in the vehicle, determining, by the processor, a power for tracking the target longitudinal acceleration, and distributing, by the processor, the determined power to front and rear wheels.

In an embodiment, the determining of the power for tracking the target longitudinal acceleration may include receiving, by the processor, sensing information from a sensor equipped in the vehicle, correcting, by the processor, the target longitudinal acceleration based on the sensing information, and determining, by the processor, the power for tracking the corrected target longitudinal acceleration.

In an embodiment, the sensing information may include information about a relative distance and a relative speed from a preceding vehicle, and the target longitudinal acceleration may be corrected by optimizing at least one of longitudinal acceleration, longitudinal jerk, or a tracking error based on a time to collision (TTC) determined based on at least a relative distance and a relative speed with respect to the preceding vehicle.

In an embodiment, the determined power may be distributed to the front/rear wheels based on the used friction ratio, which is a ratio of a current friction to a peak friction.

In an embodiment, weights for the front and rear wheels corresponding to the used friction ratio may be determined by referring to a predefined lookup table.

In an embodiment, as the used friction ratio is lower, more power may be controlled to be distributed to the rear wheels.

In an embodiment, the determined power may be distributed to the rear wheels based on the used friction ratio being equal to or less than a predetermined threshold, and the determined power may be divided and distributed to the front and rear wheels by applying a weight proportional to a load applied to each of the front wheels and the rear wheels based on the used friction ratio being greater than the threshold.

In an embodiment, the power may be distributed smaller than a value obtained by applying a certain margin to a rear line lock limit considering a tire performance limit, corresponding to the rear wheels.

In an embodiment, the distributed power may include at least one of a driving torque or a braking torque, and the method may further include transmitting, by the processor, information about the driving torque to a driving control apparatus equipped in the vehicle, and transmitting, by the processor, information about the braking torque to a braking control apparatus equipped in the vehicle.

In an embodiment, the sensing information may include at least one of information on front/rear wheel speeds, information on longitudinal/lateral acceleration, information on a yaw rate, information on a steering wheel angle, information on front/rear wheel driving torques and braking torques, information on a relative distance from a preceding vehicle, a relative speed and a relative acceleration, or SCC control flag information.

Another aspects of the present disclosure provides a computing apparatus mounted in a vehicle, including a processor configured to execute commands, and a memory configured to store the commands, and the commands may be implemented to receive information about a target longitudinal acceleration from a smart cruise control (SCC) controller equipped in the vehicle, determine a power for tracking the target longitudinal acceleration, and distribute the determined power to the front/rear wheels.

In an embodiment, the processor may be configured to receive sensing information from a sensor equipped in the vehicle, correct the target longitudinal acceleration based on the sensing information, and determine the power for tracking the corrected target longitudinal acceleration.

In an embodiment, the sensing information may include information about a relative distance and a relative speed with respect to a preceding vehicle, and the processor is configured to correct the target longitudinal acceleration by optimizing at least one of a longitudinal acceleration, longitudinal jerk, or tracking error based on a time to collision (TTC) determined based on at least a relative distance and a relative speed with respect to the preceding vehicle.

In an embodiment, the processor may be configured to distribute the determined power to the front/rear wheels based on the used friction ratio, which is a ratio of a current friction to a peak friction.

In an embodiment, the processor may be configured to determine weights for the front and rear wheels corresponding to the used friction ratio by referencing a lookup table that is predefined and stored in the memory.

In an embodiment, the processor may be configured to control more power to be distributed to the rear wheels as the used friction ratio is lower.

In an embodiment, the processor may be configured to distribute the determined power to the rear wheels based on the used friction ratio being equal to or less than a predetermined threshold, and to divide and distribute the determined power to the front and rear wheels by applying a weight proportional to a load applied to each of the front wheels and the rear wheels based on the used friction ratio being greater than the threshold.

In an embodiment, the processor may be configured to distribute the power smaller than a value obtained by applying a certain margin to a rear line lock limit considering a tire performance limit, corresponding to the rear wheels.

In an embodiment, the distributed power may include at least one of a driving torque or a braking torque for the front/rear wheels, and the processor may be configured to transmit information about the driving torque and information about the braking torque to a driving control apparatus and a braking control apparatus respectively provided in the vehicle.

In an embodiment, the sensing information may include at least one of information on front/rear wheel speeds, information on longitudinal/lateral acceleration, information on a yaw rate, information on a steering wheel angle, information on front/rear wheel driving torques and braking torques, information on a relative distance from a preceding vehicle, a relative speed and a relative acceleration, or SCC control flag information.

The present technique has an advantage of providing a vehicle motion control method capable of improving passenger ride comfort even during autonomous driving.

The present technique also has an advantage of providing a method for improving ride comfort during an operation of smart cruise control and an apparatus therefore, capable of efficiently distributing driving and braking powers to front and rear wheels to minimize vertical movement of a vehicle in a case where it is necessary to control the vehicle longitudinally with a new longitudinal acceleration.

The present technique also has an advantage of providing a method for improving ride comfort during an operation of smart cruise control and an apparatus therefore, capable of determining and applying an optimal front-rear braking power distribution ratio that minimizes an objective function between ride comfort and stability in a case where it is necessary to control the vehicle longitudinally with a new longitudinal acceleration.

Furthermore, various effects which may be directly or indirectly identified through the present specification may be provided.

### BRIEF DESCRIPTION OF THE FIGURES

FIG. 1 illustrates an example overall vehicle system.

FIG. 2 illustrates an example flowchart showing a vehicle ride comfort improving method during an operation of smart cruise control.

FIG. 3 illustrates another example flowchart showing a vehicle ride comfort improving method during an operation of smart cruise control.

FIG. 4 illustrates an example flowchart showing a method for distributing driving and braking powers to front and rear wheels for tracking target longitudinal acceleration during an operation of smart cruise control.

FIG. 5 illustrates another example flowchart showing a method for distributing driving and braking powers to front and rear wheels for tracking target longitudinal acceleration during an operation of smart cruise control.

FIG. 6 illustrates an example view for describing an optimal power distribution logic in a case of operating smart cruise control.

FIG. 7 illustrates an example view for describing a method for ensuring safety by preventing rear wheel line-lock (or wheel-lock) during smart cruise control.

FIGS. 8, 9, and 10 illustrate example views for comparing simulation performance of an optimal front/rear distribution method and a conventional rear-only distribution method.

FIG. 11 illustrates an example computing apparatus.

### DETAILED DESCRIPTION

Hereinafter, some embodiments of the present disclosure will be described in detail with reference to drawings. It should be noted that in adding reference numerals to constituent elements of each drawing, the same constituent elements include the same reference numerals as possible even though they are indicated on different drawings. In describing an embodiment of the present disclosure, when it is determined that a detailed description of the well-known configuration or function associated with the embodiment of the present disclosure may obscure the gist of the present disclosure, it will be omitted.

In describing constituent elements according to an embodiment of the present disclosure, terms such as first, second, A, B, (a), and (b) may be used. These terms are only for distinguishing the constituent elements from other constituent elements, and the nature, sequences, or orders of the constituent elements are not limited by the terms. Furthermore, all terms used herein including technical scientific terms have the same meanings as those which are generally understood by those skilled in the technical field to which an embodiment of the present disclosure pertains (those skilled in the art) unless they are differently defined. Terms defined in a generally used dictionary shall be construed to have meanings matching those in the context of a related art, and shall not be construed to have idealized or excessively formal meanings unless they are clearly defined in the present specification.

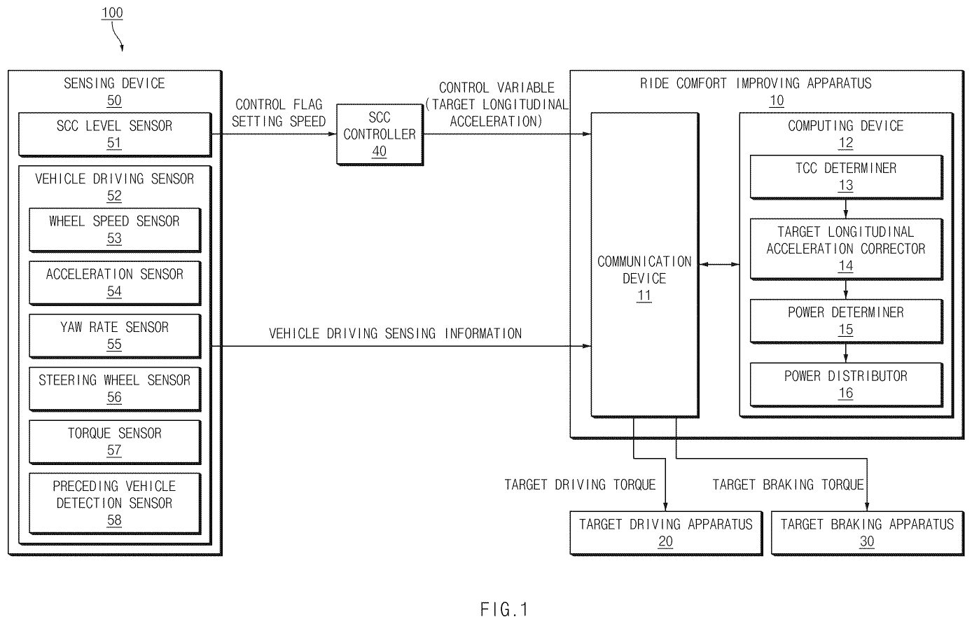

Hereinafter, various embodiments of the present disclosure will be described in detail with reference to FIG. 1 to FIG. 11.

FIG. 1 illustrates an example overall vehicle system.

Referring to FIG. 1, the vehicle system 100 may be configured to include a ride comfort improving apparatus 10, a driving control apparatus 20, a braking control apparatus 30, an SCC controller 40, and a sensing device 50.

The ride comfort improving apparatus 10 may be largely configured to include a communication device 11 and a computing device 12. Herein, the computing device 12 may be configured to include at least one of a time to collision (TTC) determiner 13, a target longitudinal acceleration corrector 14, a power determiner 15, and a power distributor 16.

The driving control apparatus 20 may be configured to control engine driving of the vehicle and may include a controller for controlling the speed of the vehicle.

The braking control apparatus 30 may be configured to control braking of the vehicle and may include a controller for controlling the brake.

The sensing device 50 may include an SCC lever sensor 51 and a vehicle driving sensor 52. Herein, the vehicle driving sensor 52 may include at least one of a wheel speed sensor 53 for measuring a speed of each wheel, an acceleration sensor 54 for measuring longitudinal/lateral acceleration, a yaw rate sensor 55 for measuring a yaw rate, a steering wheel sensor 56 for measuring a steering wheel angle, a torque sensor 57 for measuring a driving torque and a braking torque of each wheel, and a preceding vehicle detection sensor 58 for measuring a relative distance, a relative speed, and a relative acceleration of a preceding vehicle.

The SCC lever sensor 51 may detect a button input for controlling a SCC function ON/OFF of a driver to generate an SCC control flag. For example, in response to a case where the SCC function is turned on, the SCC control flag signal may be set to ‘1 (or HIGH)’ and transmitted to the SCC controller 40, and in response to a case where the SCC function is turned off, the SCC control flag may be set to ‘0 (or LOW)’ and transmitted to the SCC controller 40.

The SCC lever sensor 51 may detect a set speed according to driver manipulation of the SCC lever (or button) in response to a case where the SCC function is on, and transmit a signal corresponding to the detected set speed to the SCC controller 40.

In response to a case where the SCC function is turned on, the vehicle driving sensor 52 may transmit vehicle driving sensing information including at least one of information on wheel speed of each wheel, information on longitudinal/lateral acceleration, information on a yaw rate, information on a steering wheel angle, information on driving/braking torques of each wheel, and information on a relative distance and a relative speed with respect to a preceding vehicle to the ride comfort improving apparatus 10.

The SCC controller 40 may be configured to determine a control variable based on a driver-set speed in response to a case where the SCC function is activated according to the received SCC control flag. Herein, the control variable may include target longitudinal acceleration.

The SCC controller 40 may be configured to transmit information regarding the determined target longitudinal acceleration to the ride comfort improving apparatus 10.

The communication device 11 may transmit and receive signals to and from the SCC controller 40, the sensing device 50, a chassis domain control device, and a powertrain domain device through an in-vehicle communication network. For example, the in-vehicle communication network may include wired communications such as a controller area network (CAN), FlexRay, a local interconnect network (LIN), and Ethernet, but this is merely an example, and it may also include short-range wireless communications such as Wifi, IR (Infra-Red), Bluetooth®, Zigbee, and Z-wave.

The communication device 11 may receive information on the control variable (target longitudinal acceleration) from the SCC controller 40 to provide it to the computing device 12.

In addition, the communication device 11 may receive vehicle driving sensing information generated by the vehicle driving sensor 52 of the sensing device 50 to provide it to the computing device 12.

The computing device 12 may be configured to distribute power to the front/rear wheels based on the control variable and vehicle driving sensing information, and may transmit a distribution result to the driving control apparatus 20 and the braking control apparatus 30 through the communication device 11. That is, the computing device 12 may be configured to transmit information on a target driving torque distributed to the front/rear wheels to the driving control apparatus 20 and transmit information on a target braking torque distributed to the front/rear wheels to the braking control apparatus 30.

The TTC determiner 13 may be configured to determine a predicted time of collision with a preceding vehicle based on at least one of a relative distance, a relative speed, or a relative acceleration with the preceding vehicle.

The target longitudinal acceleration corrector 14 may be configured to adjust the target longitudinal acceleration by optimizing longitudinal acceleration, longitudinal jerk, and a tracking error according to the determined predicted collision time, so as to satisfy the ride comfort and target longitudinal acceleration tracking performance together.

The power determiner 15 may be configured to determine a driving torque and a braking torque for tracking the corrected target longitudinal acceleration.

The power distributor 15 may be configured to optimally distribute the driving torque and the braking torque calculated by considering both ride comfort and stability, to the front and rear wheels. An optimal power distribution logic of the power distributor 15 may become clearer through a description of the drawings to be described later.

The power distributor 15 may be configured to transmit information about the driving torque distributed to the front/rear wheels—that is, target front/rear wheel driving torque—to the driving control apparatus 20 via the communication device 11, and transmit information about the braking torque distributed to the front/rear wheels—that is, target front/rear wheel target braking torque—to the braking control device 30 via the communication device 11.

As described above, the vehicle system 100 according to the present disclosure may improve the ride comfort by efficiently distributing a braking/driving power to the front/rear of the vehicle such that a vertical movement of the vehicle is minimized in response to a case where the vehicle must be controlled longitudinally with a new target longitudinal acceleration value during an operation of smart cruise control.

In addition, the vehicle system 100 according to the present disclosure has an advantage of ensuring driving stability as well as improving ride comfort by determining and applying an optimal front-rear distribution ratio of braking power that takes both ride comfort and stability into account in the case where the vehicle must be controlled longitudinally with the new target longitudinal acceleration value during the operation of smart cruise control.

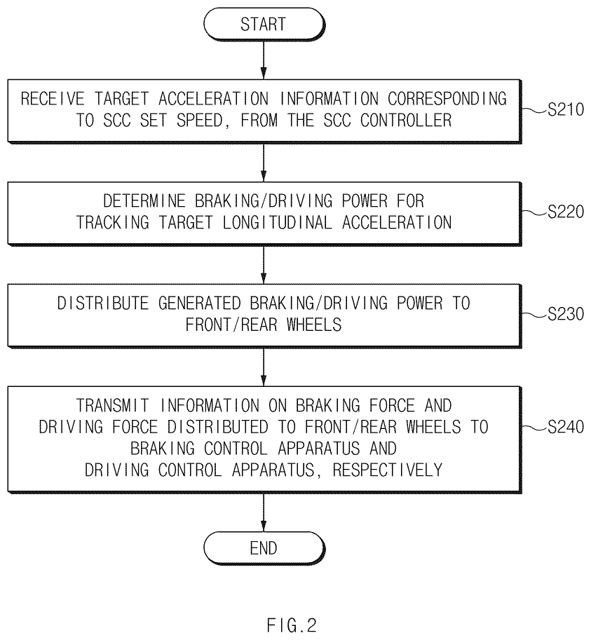

FIG. 2 illustrates an example flowchart showing a vehicle ride comfort improving method during an operation of smart cruise control.

Referring to FIGS. 1 and 2, the ride comfort improving apparatus 10 may be configured to receive target longitudinal acceleration information, which is a control variable corresponding to a SCC set speed, from the SCC controller 40 (S210).

The ride comfort improving apparatus 10 may be configured to determine a braking/driving power for tracking a target longitudinal acceleration (S220).

The ride comfort improving apparatus 10 may be configured to distribute the generated braking/driving power to front/rear wheels (S230).

The ride comfort improving apparatus 10 may be configured to transmit information on the braking force and driving force distributed to the front/rear wheels to the braking control apparatus 30 and the driving control apparatus 20, respectively (S240).

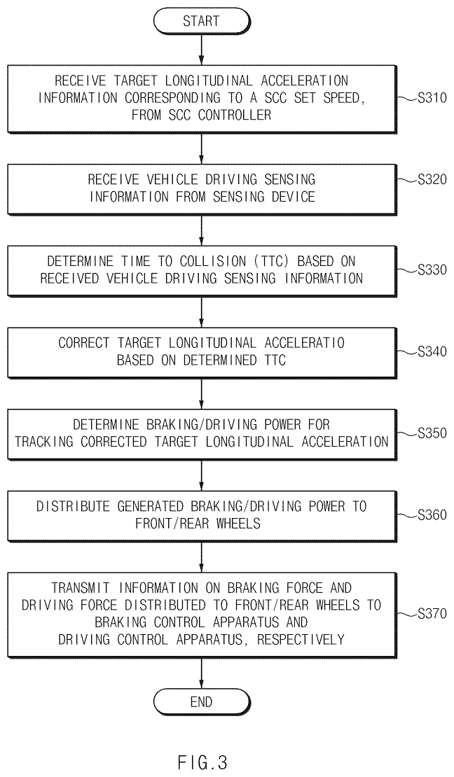

FIG. 3 illustrates another example flowchart showing a vehicle ride comfort improving method during an operation of smart cruise control.

Referring to FIGS. 1 and 3, the ride comfort improving apparatus 10 may be configured to receive target acceleration information, which is a control variable corresponding to a SCC set speed, from the SCC controller 40 (S310).

The ride comfort improving apparatus 10 may be configured to receive vehicle driving sensing information from the sensing device 50 (S320).

The ride comfort improving apparatus 10 may be configured to determine a time to collision (TTC) based on the received vehicle driving sensing information (S330).

The ride comfort improving apparatus 10 may be configured to correct the target longitudinal acceleration based on the determined TTC (S340). The ride comfort improving apparatus 10 may be configured to adjust the target longitudinal acceleration by optimizing longitudinal acceleration, longitudinal jerk, and a tracking error according to an expected time to collision (TTC) with a front vehicle, so as to satisfy the ride comfort and target longitudinal acceleration tracking performance together.

The ride comfort improving apparatus 10 may be configured to determine a braking/driving power for tracking the corrected target longitudinal acceleration (S350).

The ride comfort improving apparatus 10 may be configured to distribute the generated braking/driving power to the front/rear wheels according to the predefined optimal distribution logic (S360).

The ride comfort improving apparatus 10 may be configured to transmit information on the braking force and the driving force distributed to the front/rear wheels to the braking control apparatus 30 and the driving control apparatus 20, respectively (S370).

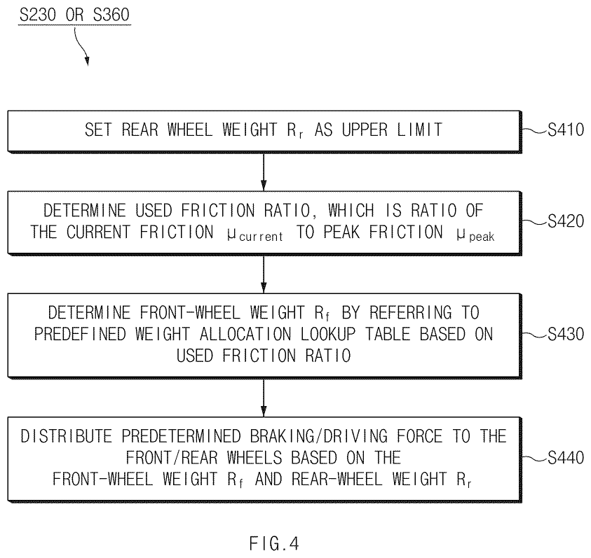

FIG. 4 illustrates an example flowchart showing a method for distributing driving and braking powers to front and rear wheels for tracking target longitudinal acceleration during an operation of smart cruise control.

Specifically, FIG. 4 may correspond to the detailed procedure of the operation 230 in FIG. 2 or the operation 360 in FIG. 3, and the ride comfort improving apparatus 10 according to the present disclosure may be implemented to distribute power by adaptively applying weights to the front/rear wheels based on a friction ratio used.

Referring to FIGS. 1 and 4, the ride comfort improving apparatus 10 may be configured to set a rear wheel weight Rᵣ as an upper limit (S410). Herein, a front wheel weight R_{f} may be set as a lower limit. That is, considering the ride comfort in general acceleration/deceleration situations, a default rear-wheel-centered distribution strategy may be applied.

The ride comfort improving apparatus 10 may determine the used friction ratio, which is a ratio of the current friction μ_{current} to the peak friction μₚₑₐₖ (S420). Herein, the frictional force ratio used may be determined as

$$\frac{{μ}_{current}}{{μ}_{peak}} .$$

The ride comfort improving apparatus 10 may be configured to determine a front-wheel weight R_{f} by referring to a predefined weight allocation lookup table based on the used friction ratio (S430). The ride comfort improving apparatus 10 according to the present disclosure may be configured to apply a strategy to optimally distribute power to the front and rear wheels while considering ride comfort and stability in response to a case where the required acceleration increases and the frictional force ratio increases.

The ride comfort improving apparatus 10 may be configured to distribute predetermined braking/driving force to the front/rear wheels based on the front-wheel weight R_{f} and rear-wheel weight Rᵣ (S440).

As in the embodiment of FIG. 4 described above, the ride comfort improving apparatus 10 according to the present disclosure has an advantage of satisfying both ride comfort and stability by applying a default rear-wheel-focused distribution strategy to improve ride comfort in general acceleration/deceleration situations, and then adaptively distributing the braking/driving force to the front and rear wheels based on the used friction ratio.

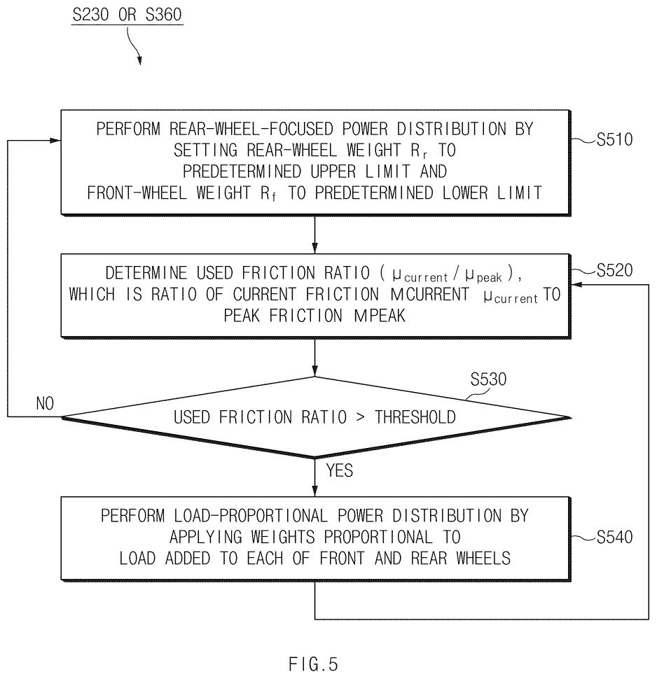

FIG. 5 illustrates another example flowchart showing a method for distributing driving and braking powers to front and rear wheels for tracking target longitudinal acceleration during an operation of smart cruise control.

In detail, FIG. 5 may correspond to the detailed procedure of the operation 230 of FIG. 2 or the operation 360 of FIG. 3, and the ride comfort improving apparatus 10 according to the present disclosure may be implemented to distribute the braking/driving power by adaptively applying weights to the front/rear wheels after comparing the used friction ratio with a predetermined threshold.

The ride comfort improving apparatus 10 may be configured to perform rear-wheel-focused power distribution by setting the rear-wheel weight Rᵣ to a predetermined upper limit and the front-wheel weight R_{f} to a predetermined lower limit as the default strategy (S510).

The ride comfort improving apparatus 10 may be configured to determine the used friction ratio (μ_{current}/μₚₑₐₖ), which is a ratio of the current friction μ_{current} to a peak friction μₚₑₐₖ (S520).

The ride comfort improving apparatus 10 may be configured to compare the determined used friction ratio with a predetermined threshold (S530).

As a result of the comparison, in response to a case where the used friction ratio exceeds a threshold, the ride comfort improving apparatus 10 may be configured to perform load-proportional power distribution by applying weights proportional to a load added to each of the front and rear wheels (S540).

As in the embodiment of FIG. 5 described above, the ride comfort improving apparatus 10 according to the present disclosure has an advantage of satisfying both ride comfort and stability by applying the default rear-wheel-focused distribution strategy, which provides excellent ride comfort in the general acceleration/deceleration situations, and by applying a strategy of distributing braking/driving force in proportion to a load applied to the front/rear wheels in response to a case where the required acceleration increases and the used friction ratio exceeds a predetermined threshold.

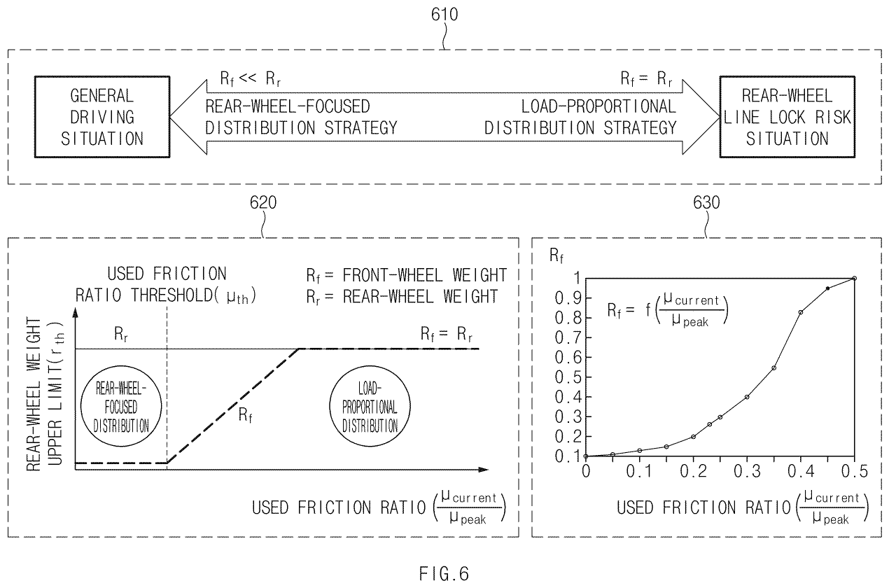

FIG. 6 illustrates an example view for describing an optimal power distribution logic in a case of operating smart cruise control.

Specifically, FIG. 6 illustrates a view for describing the optimal power distribution logic that improves ride comfort in terms of pitch/vertical behavior and enhances stability in situations such as rear-wheel lock by adaptively controlling power distribution weights for front/rear wheels according to the used friction ratio in the case of operating the smart cruise control.

Referring to reference numeral 610, the optimal power distribution logic according to the present disclosure may apply a rear-wheel-focused distribution strategy in general acceleration/deceleration driving situations, and a load-proportional distribution strategy in situations where required acceleration increases and a risk of rear-wheel line lock increases.

Referring to reference numeral 620, in a general acceleration/deceleration driving situation, that is, in a case where the used friction ratio is equal to or less than a predetermined threshold, the rear-wheel-focused distribution strategy may be applied, and in a case where the used friction ratio is greater than the threshold, the load-proportional distribution strategy may be applied. In a case where the used friction ratio approaches that in a rear-wheel line lock risk situation, a front-wheel weight R_{f} and a rear-wheel weight Rᵣ may be applied equally, to achieve the braking/driving force distribution.

Reference numeral 630 shows a lookup function

$${R}_{f} = f ( \frac{{μ}_{current}}{{μ}_{peak}} )$$

for front-wheel weight allocation according to the used friction ratio. The ride comfort improving apparatus 10 according to an embodiment of the present disclosure may be configured to store and maintain a lookup table created based on the lookup function in an internal memory mounted therein.

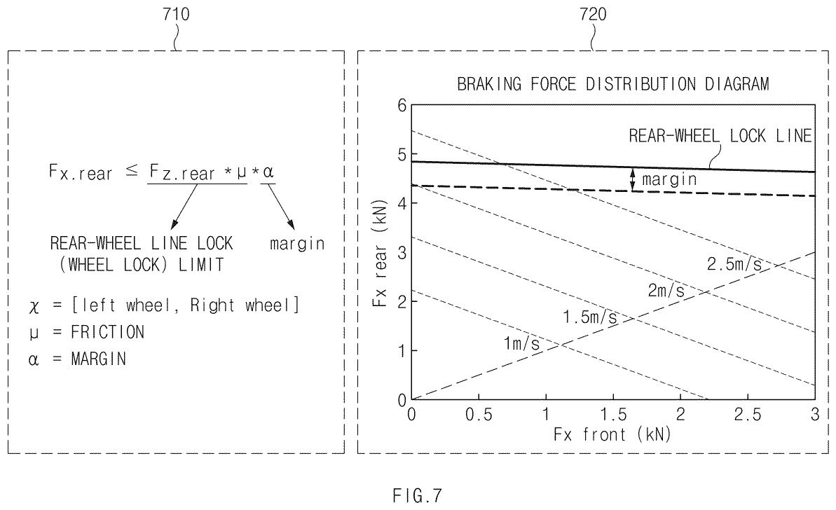

FIG. 7 illustrates an example view for describing a method for ensuring safety by preventing rear wheel line-lock (or wheel-lock) during smart cruise control.

Referring to FIG. 7, the ride comfort improving apparatus 10 according to the present disclosure may be configured to distribute the rear-wheel braking/driving force to be less than the value with a certain margin applied from the rear-wheel line lock limit (wheel lock) to prevent a decrease in driving stability due to the rear-wheel line lock, i.e., tire performance limit, on low-friction surfaces, as shown in an equation in reference numeral 710. Herein, the margin may be set to a certain ratio to the rear wheel lock line, as shown in reference numeral 720. For example, the margin may be set to 10%, but the present disclosure is not limited thereto, and may be set to a lower or higher ratio based on a design of a person skilled in the art.

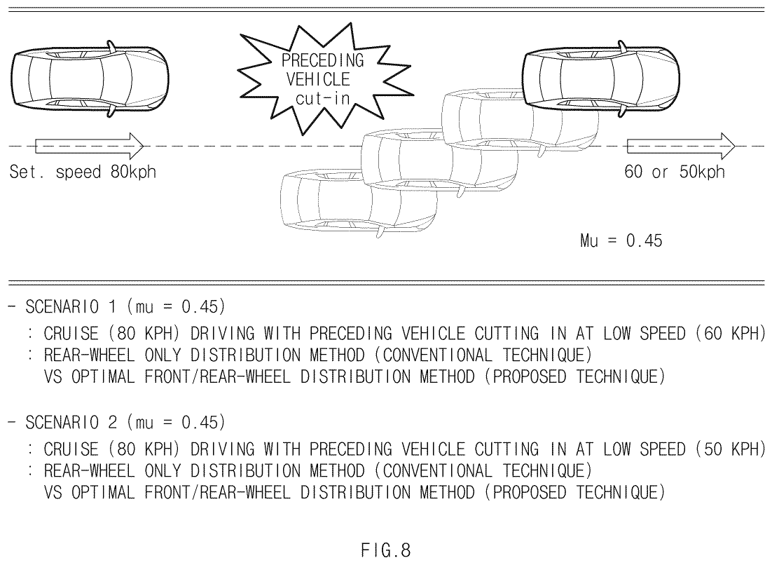

FIGS. 8 to 10 illustrate example views for comparing simulation performance of an optimal front/rear distribution method and a conventional rear-only distribution method.

Referring to FIG. 8, according to Scenario 1, simulation performance is measured for a situation where a preceding vehicle cuts in at 60 kph while driving at a set speed of 80 kph with smart cruise control function activated, comparing a rear-wheel only distribution method (conventional technique) versus an optimal front/rear-wheel distribution method (proposed technique). According to Scenario 2, simulation performance is measured for a situation where a preceding vehicle cuts in at 50 kph while driving at a set speed of 80 kph with the smart cruise control function activated, comparing the rear-wheel only distribution method (conventional technique) versus the optimal front/rear-wheel distribution method (proposed technique).

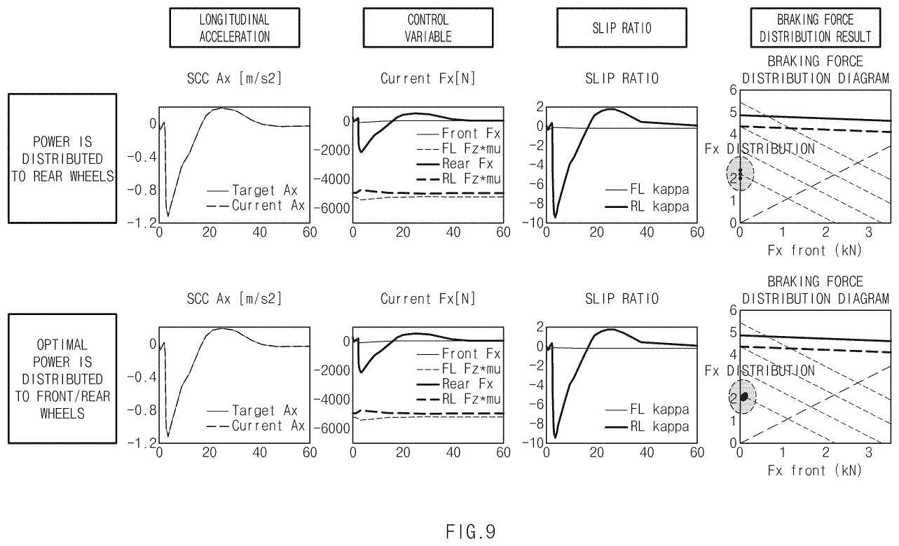

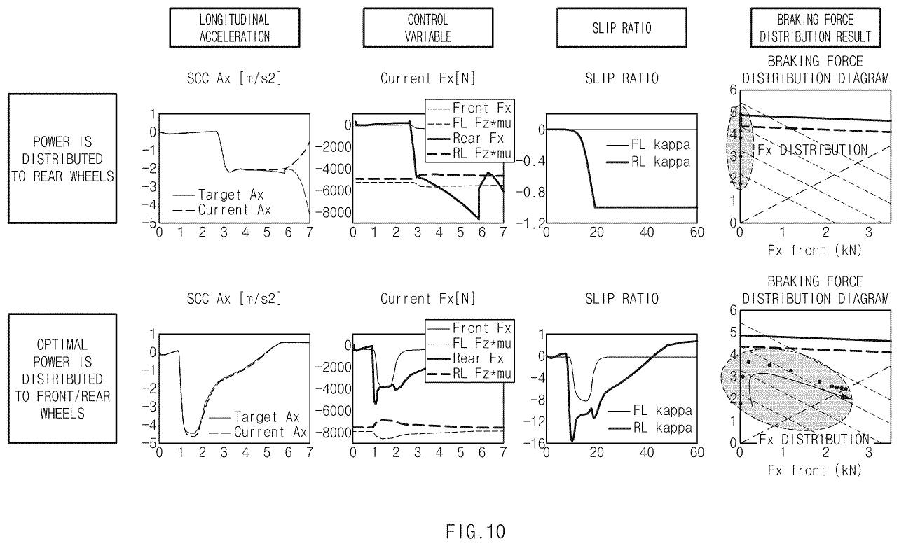

FIG. 9 shows a simulation result according to Scenario 1 of FIG. 8, and FIG. 10 shows a simulation result according to Scenario 2 of FIG. 8.

Referring to FIG. 9, in a case of Scenario 1, where the required control variable is small, the rear-wheel only power distribution strategy (conventional technique) and the optimal front/rear-wheel power distribution strategy (proposed technique) show equivalent performance in terms of longitudinal acceleration, control variable, slip rate, and braking distribution results.

However, in the case of Scenario 2, where the required control amount is large, the rear-wheel only power distribution strategy (conventional technique) and the optimal front/rear-wheel power distribution strategy (proposed technique) show significant performance differences in terms of longitudinal acceleration, control variable, slip rate, and braking distribution results.

As described above, the optimal power distribution logic according to the present disclosure has an advantage of improving ride comfort in a case of operating smart cruise control by minimizing vertical motions such as pitch in response to distributing braking force.

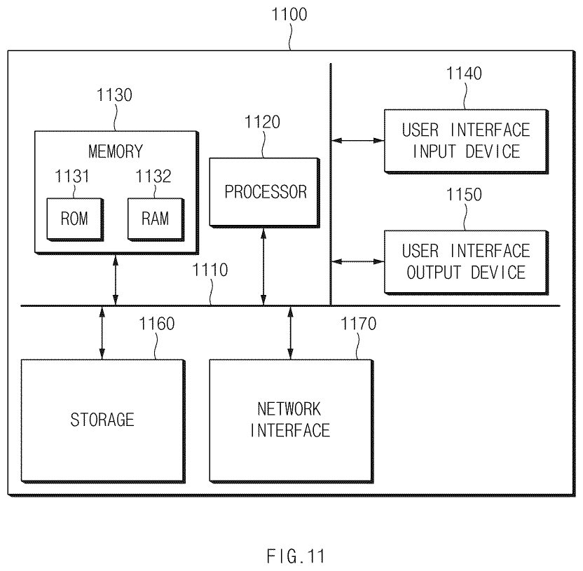

FIG. 11 illustrates an example computing apparatus.

Referring to FIG. 11, the computing apparatus 1100 may be configured to include at least one of at least one processor 1120 connected through a bus 1110, a memory 1130, a user interface input device 1140, a user interface output device 1150, and a storage 1160, or a network interface 1170.

The network interface 1170 may provide at least one of a wired communication means or a wireless communication means for transmitting and receiving control signals and data between components of the vehicle system 100.

The processor 1120 may be a central processing unit (CPU) or a semiconductor device that performs processing on commands stored in the memory 1130 and/or the storage 1160. The memory 1130 and the storage 1160 may include various types of volatile or nonvolatile storage media. For example, the memory 1130 may include a read only memory (ROM) 1131 and a random access memory (RAM) 1132.

Accordingly, operations of a method (or procedure) or algorithm described in connection with the exemplary embodiments included herein may be directly implemented by hardware, a software module, or a combination of the two, executed by the processor 1120. The software module may reside in a storage medium (i.e., the memory 1130 and/or the storage 1160) such as a RAM memory, a flash memory, a ROM memory, an EPROM memory, an EEPROM memory, a register, a hard disk, a removable disk, and a CD-ROM. For example, the processor 1120 may form part of the ride comfort improving apparatus 10 described above.

An example storage medium is coupled to the processor 1120, which can read information from and write information to the storage medium. Alternatively, the storage medium may be integrated with the processor 1120. The processor and the storage medium may reside within an application specific IC (ASIC). The ASIC may reside in a controller within a vehicle. Alternatively, the processor 1120 and the storage medium may reside as separate components within the controller of the vehicle system 100.

The above description is merely illustrative of the technical idea of the present disclosure, and those skilled in the art to which the present disclosure pertains may make various modifications and variations without departing from the essential characteristics of the present disclosure.

Therefore, the embodiments disclosed in the present disclosure are not intended to limit the technical ideas of the present disclosure, but to explain them, and the scope of the technical ideas of the present disclosure is not limited by these embodiments. The protection range of the present disclosure should be interpreted by the claims below, and all technical ideas within the equivalent range should be interpreted as being included in the scope of the present disclosure.

1. A ride comfort improving method for a vehicle, comprising:
receiving, by a processor, information on a target longitudinal acceleration from a smart cruise control (SCC) controller positioned in the vehicle;
determining, by the processor, a power for tracking the target longitudinal acceleration; and
distributing, by the processor, the determined power to a plurality of front wheels and a plurality of rear wheels.

2. The method of claim 1, wherein the determining of the power for tracking the target longitudinal acceleration includes:
receiving, by the processor, sensing information from a sensor positioned in the vehicle;
correcting, by the processor, the target longitudinal acceleration based on the sensing information; and
determining, by the processor, the power for tracking the corrected target longitudinal acceleration.

3. The method of claim 2, wherein:
the sensing information includes information about a relative distance and a relative speed from a preceding vehicle; and
the target longitudinal acceleration is corrected by optimizing at least one of longitudinal acceleration, longitudinal jerk, or a tracking error based on a time to collision (TTC) determined based on at least a relative distance and a relative speed with respect to the preceding vehicle.

4. The method of claim 1, wherein the determined power is distributed to the plurality of front wheels and the plurality of rear wheels based on a used friction ratio, which is a ratio of a current friction to a peak friction.

5. The method of claim 4, wherein weights for the plurality of front wheels and the plurality of rear wheels corresponding to the used friction ratio are determined by referencing a predefined lookup table.

6. The method of claim 4, wherein as the used friction ratio is less than a predetermined threshold, more power is distributed to the plurality of rear wheels.

7. The method of claim 5, wherein the determined power is distributed to the rear wheels based on the used friction ratio being equal to or less than a predetermined threshold, and the determined power is divided and distributed to the plurality of front wheels and the plurality of rear wheels by applying a weight proportional to a load applied to each of the plurality of front wheels and each of the plurality of rear wheels based on the used friction ratio being greater than the predetermined threshold.

8. The method of claim 7, wherein the power is distributed less than a value obtained by applying a certain margin to a rear line lock limit based on a tire performance limit, corresponding to the plurality of rear wheels.

9. The method of claim 1, wherein the distributed power includes at least one of a driving torque or a braking torque, and wherein the method further comprises:
transmitting, by the processor, information about the driving torque to a driving control apparatus positioned in the vehicle; and
transmitting, by the processor, information about the braking torque to a braking control apparatus positioned in the vehicle.

10. The method of claim 1, wherein the sensing information includes at least one of information on a front wheel speed and a rear wheel speed, information on longitudinal and lateral acceleration, information on a yaw rate, information on a steering wheel angle, information on front wheel driving torques and braking torques and rear wheel driving torques and braking torques, information on a relative distance from a preceding vehicle, a relative speed and a relative acceleration, or SCC control flag information.

11. A computing apparatus mounted in a vehicle, comprising:
a memory storing computer-executable instructions; and
at least one processor configured to access the memory and execute the instructions, wherein the instructions comprise:
receiving information about a target longitudinal acceleration from a smart cruise control (SCC) controller positioned in the vehicle;
determining a power for tracking the target longitudinal acceleration; and distributing the determined power to a plurality of front wheels and a plurality of rear wheels.

12. The computing apparatus of claim 11, wherein the instructions further comprise:
receiving sensing information from a sensor positioned in the vehicle;
correcting the target longitudinal acceleration based on the sensing information; and
determining the power for tracking the corrected target longitudinal acceleration.

13. The computing apparatus of claim 12, wherein the sensing information includes information about a relative distance and a relative speed with respect to a preceding vehicle, and the instructions further comprise correcting the target longitudinal acceleration by optimizing at least one of a longitudinal acceleration, longitudinal jerk, or tracking error based on a time to collision (TTC) determined based on at least a relative distance and a relative speed with respect to the preceding vehicle.

14. The computing apparatus of claim 11, wherein the instructions further comprise distributing the determined power to the plurality of front wheels and the plurality of rear wheels based on the used friction ratio, which is a ratio of a current friction to a peak friction.

15. The computing apparatus of claim 14, wherein the instructions further comprise determining weights for the plurality of front wheels and the plurality of rear wheels corresponding to the used friction ratio by referencing a lookup table that is predefined and stored in the memory.

16. The computing apparatus of claim 14, wherein the instructions further comprise distributing more power to the plurality of rear wheels when the used friction ratio is less than a predetermined threshold.

17. The computing apparatus of claim 15, wherein the instructions further comprise distributing the determined power to the plurality of rear wheels based on the used friction ratio being equal to or less than a predetermined threshold, and dividing and distributing the determined power to the plurality of front wheels and the plurality of rear wheels by applying a weight proportional to a load applied to each of the plurality of front wheels and each of the plurality of rear wheels based on the used friction ratio being greater than the predetermined threshold.

18. The computing apparatus of claim 17, wherein the instructions further comprise distributing the power smaller than a value obtained by applying a certain margin to a rear line lock limit based on a tire performance limit, corresponding to the plurality of rear wheels.

19. The computing apparatus of claim 11, wherein the distributed power includes at least one of a driving torque or a braking torque for the plurality of front wheels and the plurality of rear wheels, and the instructions further comprise transmitting information about the driving torque to a driving control apparatus and information about the braking torque to a braking control apparatus positioned in the vehicle.

20. The computing apparatus of claim 11, wherein the sensing information includes at least one of information on a front wheel speed and a rear wheel speed, information on longitudinal and lateral acceleration, information on a yaw rate, information on a steering wheel angle, information on front wheel driving torques and braking torques and rear wheel driving torques and braking torques, information on a relative distance from a preceding vehicle, a relative speed and a relative acceleration, or SCC control flag information.
